(19) United States
(12) Patent Application Publication
(10) Pub. No.: US 2002/0070071 A1
(43) Pub. Date: Jun. 13, 2002

(54) Electro-hydraulic load sense on a power machine

(76) Inventor: Scott N. Schuh, Fort Ransom, ND (US)

Correspondence Address: Joseph R. Kelly, WESTMAN CHAMPLIN & KELLY, International Centre-Suite 1600, 900 South Second Avenue, Minneapolis, MN, 55402-3319, US

(21) Appl. No.: 09/733,110

(22) Filed: Dec. 8, 2000

(51) Int. Cl. B62D 5/06; B62D 7/06

(52) U.S. Cl. 180/421; 180/408

(57) ABSTRACT

A power machine includes one or more steerable wheels. The wheels are steerable using a hydraulic actuator to drive steering movement of the wheels. The power machine also includes steering angle sensors which sense the steering angle and provide a signal indicative of the angle at which the wheels are disposed relative to a longitudinal axis of the power machine. A hydraulic control system controls pressure of hydraulic fluid provided to the steering actuators based upon the steer angle position and desired change in position over time sensed by the steer angle sensors.

### BACKGROUND OF THE INVENTION

The present invention generally relates to power machines. More specifically, the present invention relates to utilizing electronic position sensing to vary hydraulic pressure in an electro-hydraulic control system.

Power machines, such as loaders, typically have a number of power actuators. Such actuators can include, for example, drive actuators or motors which provide traction power to the wheels or tracks of the machine. The actuators can also include those associated with manipulating a primary working tool, such as a bucket. In that case, the actuators include lift and tilt actuators. Of course, a wide variety of other actuators can also be used on such power machines. Examples of such actuators include auxiliary actuators, hand-held or remote tool actuators or other actuators associated with the operation of the power machine itself, or a tool coupled to the power machine.

The various actuators on such power machines have conventionally been controlled by mechanical linkages. For example, when the actuators are hydraulic actuators controlled by hydraulic fluid under pressure, they have been controlled by user input devices such as handles, levers, or foot pedals. The user input devices have been connected to a valve spool (of a valve which controls the flow of hydraulic fluid under pressure to the hydraulic actuator) by a mechanical linkage. The mechanical linkage transfers the user input motion into linear displacement of the valve spool to thereby control flow of hydraulic fluid to the actuator.

Electronic control inputs have also been developed. The electronic inputs include an electronic sensor which senses the position of user actuable input devices (such as hand grips and foot pedals). In the past, such sensors have been resistive-type sensors, such as rotary or linear potentiometers.

In some power machines, such as loaders, the wheels are independently steerable relative to one another. In order to steer the wheels, hydraulic actuators can be coupled to the frame or chain case of the loader and to the wheel mounting assembly such that extension and retraction of the hydraulic cylinder causes turning of the wheel relative to the longitudinal axis of the loader (i.e., it causes steering of the wheel).

In traditional hydraulic control systems, one or more shuttle valves, or two or more check valves are conventionally used in order to determine or regulate the maximum load or pressure required by the system. Such additional valves, of course, require hydraulic plumbing and thus add undesirable cost and assembly time to the hydraulic control system in the loader.

### SUMMARY OF THE INVENTION

A power machine, in one embodiment, includes one or more steerable wheels. The wheels are steerable using a hydraulic actuator to drive steering movement of the wheels. The power machine also includes steering angle sensors which sense the steering angle and provide a signal indicative of the angle at which the wheels are disposed relative to a longitudinal axis of the power machine. An electro-hydraulic control system controls pressure of hydraulic fluid provided to the steering actuators based upon the change in steer angle sensed by the steer angle sensors.

### BRIEF DESCRIPTION OF THE DRAWINGS

FIG. 1 is a side elevational view of a power machine in accordance with one embodiment of the present invention.

FIG. 2 is a perspective view illustrating a transmission of the power machine shown in FIG. 1, with the motor and portions of the chain case removed for the sake of clarity.

FIG. 3 is a schematic diagram of a portion of a hydraulic control system in accordance with the prior art.

FIG. 4 is a schematic diagram of a portion of a hydraulic control system in accordance with one embodiment of the present invention.

### DETAILED DESCRIPTION OF THE ILLUSTRATIVE EMBODIMENTS

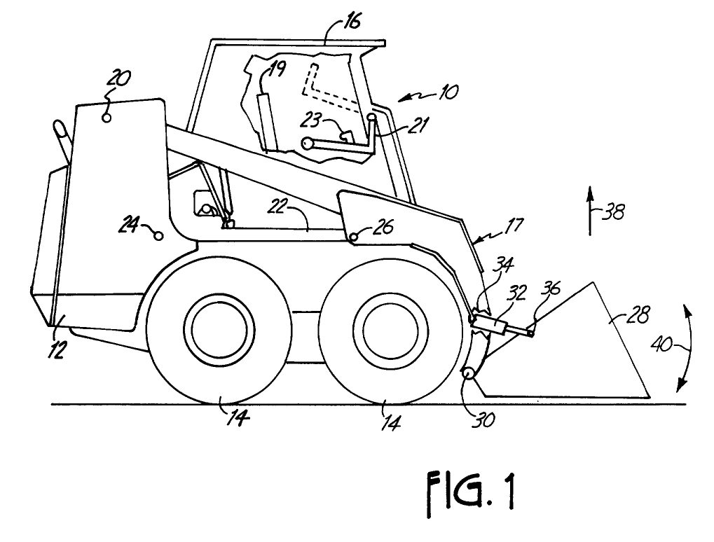

FIG. 1 is a side elevational view of one embodiment of a loader 10 according to the present invention. Loader 10 includes a frame 12 supported by wheels 14. Frame 12 also supports a cab 16 which defines an operator compartment and which substantially encloses a seat 19 on which an operator sits to control skid steer or all wheel steer loader 10. A seat bar 21 is optionally pivotally coupled to a portion of cab 16 while seat bar 21 is shown pivoting at a front portion of cab 16, it could also, optionally, pivot at the rear of cab 16. When the operator occupies seat 19, the operator then pivots seat bar 21 from the raised position (shown in phantom in FIG. 1) to the lowered position shown in FIG. 1.

A pair of steering joysticks 23 (only one of which is shown in FIG. 1) are mounted within cab 16. One of joysticks 23 is manipulated by the operator to control forward and rearward movement of loader 10, and in order to steer loader 10, while the other controls loader functions.

A lift arm 17 is coupled to frame 12 at pivot points 20 (only one of which is shown in FIG. 1, the other being identically disposed on the opposite side of loader 10). A pair of hydraulic cylinders 22 (only one of which is shown in FIG. 1) are pivotally coupled to frame 12 at pivot points 24 and to lift arm 17 at pivot points 26. Lift arm 17 is coupled to a working tool which, in this embodiment, is a bucket 28. Lift arm 17 is pivotally coupled to bucket 28 at pivot points 30. In addition, another hydraulic cylinder 32 is pivotally coupled to lift arm 17 at pivot point 34 and to bucket 28 at pivot point 36. While only one cylinder 32 is shown, it is to be understood that any desired number of cylinders can be used to work bucket 28 or any other suitable tool.

The operator residing in cab 16 manipulates lift arm 17 and bucket 28 by selectively actuating hydraulic cylinders 22 and 32. In prior loaders, such actuation was accomplished by manipulation of foot pedals in cab 16 attached to mechanical linkages or by actuation of hand grips in cab 16 attached to cables. The linkages and cables were attached to valves (or valve spools) which control operation of cylinders 22 and 32. However, this actuation can also be accomplished by moving a movable element, such as a joystick, foot pedal or user actuable switch or button on a hand grip or joystick 23 and electronically controlling movement of cylinders 22 and 32 based on the movement of the movable element. In one embodiment, movement of the movable elements is sensed by a controller in the hand grip and is communicated to a main control computer used to control the valves which port oil to cylinders and other hydraulic or electronic functions on a loader 10.

By actuating hydraulic cylinders 22 and causing hydraulic cylinders 22 to increase in length, the operator moves lift arm 17, and consequently bucket 28, generally vertically upward in the direction indicated by arrow 38. Conversely, when the operator actuates cylinder 22 causing it to decrease in length, bucket 28 moves generally vertically downward to the position shown in FIG. 1.

The operator can also manipulate bucket 28 by actuating cylinder 32. This is also illustratively done by pivoting or actuating a movable element (such as a foot pedal or a hand grip on a joystick or a button or switch on a handgrip) and electronically controlling cylinder 32 based on the movement of the element. When the operator causes cylinder 32 to increase in length, bucket 28 tilts forward about pivot points 30. Conversely, when the operator causes cylinder 32 to decrease in length, bucket 28 tilts rearward about pivot points 30. The tilting is generally along an arcuate path indicated by arrow 40.

While this description sets out many primary functions of loader 10, a number of others should be mentioned as well. For instance, loader 10 may illustratively include blinkers or turn signals mounted to the outside of the frame 12. Also loader 10 may include a horn and additional hydraulic couplers, such as front and rear auxiliaries, which may be controlled in an on/off or proportional fashion. Loader 10 may also be coupled to other tools which function in different ways than bucket 28. Therefore, in addition to, or instead of, the hydraulic actuators described above, loader 10 may illustratively include many other hydraulic or electronic actuators as well.

In one illustrative embodiment, loader 10 is an all-wheel steer loader. Each of the wheels is both rotatable and pivotable on the axle on which it is supported. Pivoting movement can be driven using a wide variety of mechanisms, such as a hydraulic cylinder, an electric motor, etc. For the sake of clarity, the present description will proceed with respect to the wheels being individually steered with hydraulic cylinders.

In addition, loader 10 illustratively includes at least two drive motors, one for the pair of wheels on the left side of the vehicle and one for the pair of wheels on the right side of the vehicle. Of course, loader 10 could also include a single drive motor for all four wheels, or a drive motor associated with each wheel.

By moving or pivoting the handgrip or a set of steering levers located in the operator's compartment, the operator controls the hydrostatic pumps. In doing so, the operator controls both direction of rotation of the hydrostatic motors, and motor speed. This allows the operator to control the fore/aft movement of the loader, as well as loader direction and speed.

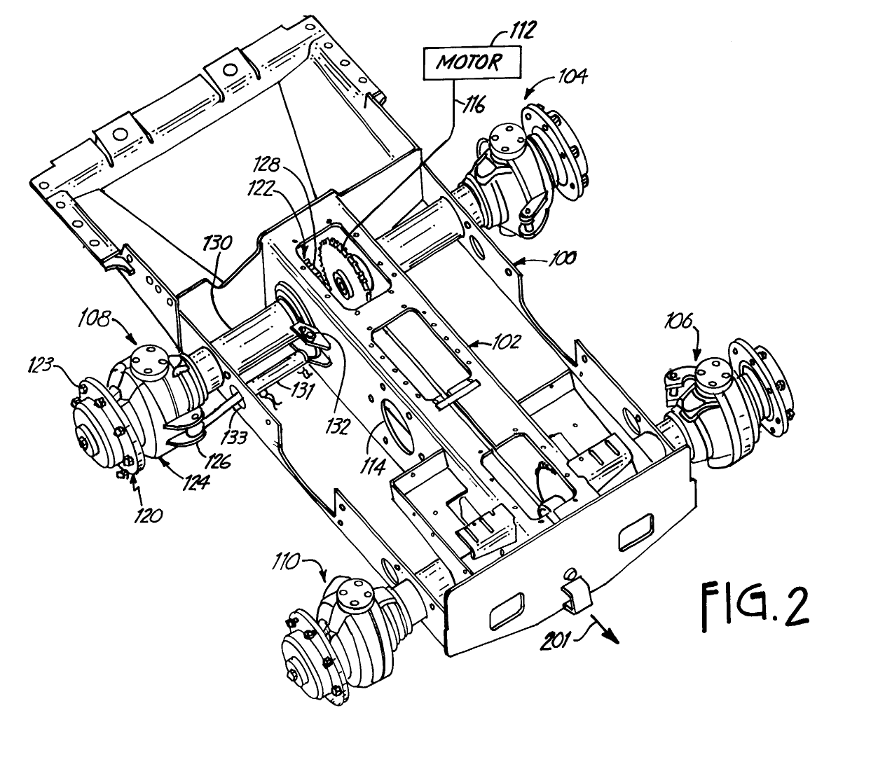

FIG. 2 is a perspective view of a portion of loader 10, with the upper portion of loader 10 removed exposing only a chassis or structural body portion 100 as well as a chain case 102. FIG. 2 also illustrates four transmission assemblies 104, 106, 108 and 110 which are used to allow rotation of wheels 14 on loader 10. FIG. 2 also illustrates a motor 112 diagrammatically. It will be appreciated that motor 112 is illustratively a hydrostatic motor connected through aperture 114 in chain case 102. Motor 112 illustratively includes a rotatable output drive shaft and sprocket assembly which is connected to a corresponding sprocket assembly on a corresponding transmission by a chain drive linkage diagrammatically illustrated by arrow 116. It will also be appreciated that from one to four motors 112 can be provided on loader 10 such that a single motor drives all wheels or such that some of the wheels are individually driven or are driven in pairs. For the sake of clarity, only a single motor 112 is diagrammatically shown in FIG. 2. Transmissions 104-110 are illustratively substantially identical to one another. Therefore, the present description will proceed only with respect to transmission 108.

Transmission 108 includes an outboard end 120 and an inboard end 122. Outboard end 120 includes a tire mounting hub 122, a universal joint 124, and a steering connection tab 126. Inboard end 122 includes a sprocket assembly 128. The inboard end 122 is connected to the outboard end 120 by an axle assembly 130.

In order to steer the tires mounted on hub 123 a hydraulic cylinder 131 is coupled at a pivot axis 132 on chain case 102 and to steering tabs 126 on swivel 124. In one illustrative embodiment, hydraulic cylinder 131 has its base end, and all hoses and hose couplings, on the interior of structural body member 100, and only the rod end of cylinder 131 extends through an aperture 133 in structural body member 100 to connect to tabs 126.

Cylinder 131 is illustratively connected to a hydraulic power system in loader 10 which provides hydraulic fluid under pressure to the base and rod ends of cylinder 131 through the hoses and couplings to lengthen or shorten the cylinder, respectively. The valves controlling provision of hydraulic fluid under pressure to cylinder 131 are illustratively controllable by user inputs located within the operator compartment of loader 10. When the operator causes cylinder 131 to be lengthened or shortened, this consequently causes the wheel mounted to hub 123 to be turned in opposite directions at swivel 124.

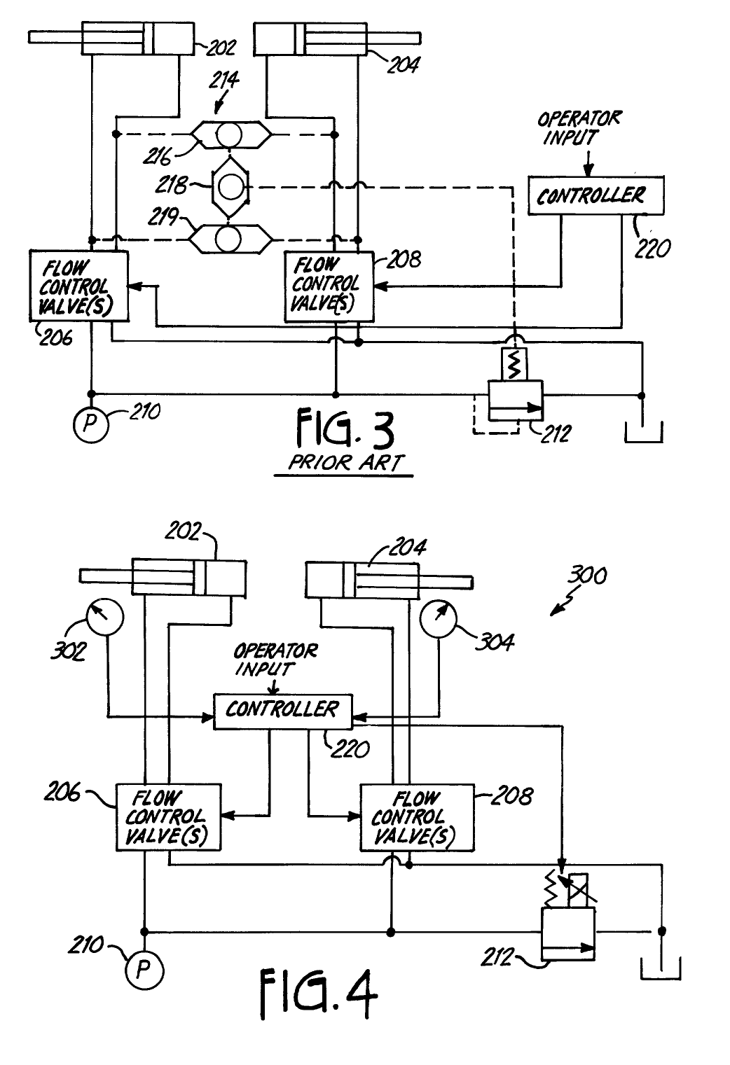

FIG. 3 illustrates one prior art embodiment of a hydraulic control system for controlling a maximum pressure provided at a pair of cylinders. FIG. 3 illustrates cylinders 202 and 204, along with flow control valves 206 and 208. FIG. 3 also illustrates pump 210, proportional pressure control valve 212, a network of shuttle or check valves collectively referred to as valves 214 and specifically include valves 216, 218 and 220, and controller 220. In one illustrative embodiment, hydraulic cylinders 202 and 204 corresponded to steering cylinders (such as cylinder 131 shown in FIG. 2) mounted to the power machine for steering the wheels of the power machine.

In operation, the operator provides a steering input to controller 220 such as through handgrips, control levers, joysticks, etc. in the operator compartment of loader 10. In response, controller 220 provides control signals to flow control valves 206 and 208 to provide hydraulic fluid under pressure, from pump 210, to either the base or rod end of hydraulic actuators 202 and 204, depending upon the direction which the user wishes to steer the wheels associated with the hydraulic cylinders 202 and 204.

Proportional pressure control valve 212, when fully open, allows hydraulic fluid under pressure provided by pump 10 to flow directly to tank and thus reduces the pressure provided through valves 206 and 208 to essentially zero. However, when controller 220 decreases the control current provided to valve 212, valve 212 begins to close, in a manner proportional to the pilot pressure from valves 214. As valve 212 closes, pressure in the hydraulic system builds such that the pressure provided by pump 210, through control valves 206 and 208, to cylinder 202 and 204 increases so the cylinder can be actuated to steer the wheels. Valves 216, 218 and 219 are plumbed across the various inputs to cylinders 202 and 204, and are connected to one another and communicate the highest pressure back to the pressure control valve 212. In other words, if the pressure becomes unbalanced, or exceeds a maximum pressure, the valves open to provide a pilot pressure to valve 212, causing valve 212 to open incrementally based upon the pilot pressure provided. This tends to change the pressure in the hydraulic system and thus set the optimum pressure which can be provided to cylinders 202 and 204.

FIG. 4 is a schematic diagram of a hydraulic control system 300 in accordance with one embodiment of the present invention. A number of the items in hydraulic control system 300 are similar to those shown in FIG. 3, and are similarly numbered. However, FIG. 4 illustrates that valves 214 have been completely eliminated from hydraulic control system 300 and position sensors 302 and 304 have been added as have components to accomplish electrical proportional pressure control.

In one illustrative embodiment, position sensors 302 and 304 are angle sensors which sense the angle at which the wheels associated with hydraulic cylinders 202 and 204 are steered relative to, for example, the longitudinal axis of the loader (as shown in FIG. 2). In one illustrative embodiment, steer angle sensors 302 and 304 are rotary potentiometers which are mounted relative to kingpin bearings in the power machine such that, as the wheel pivots to steer the power machine, the signal provided by sensors 302 and 304 changes to indicate an angle at which the wheels are steered.

Of course, sensors 302 and 304 can be any other suitable sensors which will provide an output indicative of the steering of the wheels associated with the hydraulic cylinders 202 and 204. For example, sensors 302 and 304 could simply be position sensors which sense the linear extent to which cylinders 202 and 204 are extended. This, in turn, gives an indication of the angle at which the wheels are steered. In that embodiment, sensors 302 and 304 can be Hall effect sensors or resistive strip-type sensors, or any other suitable sensor, as desired. In any case, sensors 302 and 304 provide a signal to controller 220 which is indicative of the steering angle of the wheels.

In operation, controller 220 first receives an operator input indicative of a demanded steering operation. As with the description with respect to FIG. 3, this can be an operator input from a handgrip, hand lever, foot pedal, joystick, or any other operator input which is used by the operator to indicate a desired steering operation.

Controller 220 then provides a control output to valve 212. In one illustrative embodiment, under normal operating circumstances, when steering is not demanded, controller 220 provides a full current signal to valve 212, such that valve 212 is fully opened. This reduces the steering control system pressure to valves 206 and 208 to near zero pressure. When steering is demanded through the operator input, controller 220 reduces the current, in the illustrative embodiment, provided to valve 212 to begin closing valve 212 in a proportional manner. Thus, pressure in the steering control system begins to build. Substantially simultaneously, controller 220 provides control valves 206 and 208 to control the flow of hydraulic fluid under pressure to either the rod or base end of hydraulic cylinders 202 and 204, depending upon the specific steering operation which has been demanded by the operator.

Controller 220 monitors the sensor signals provided by sensors 302 and 304 to determine whether hydraulic cylinders 202 and 204 have been able to steer the wheels to a sufficient steer angle. The controller must also maintain a relationship between the positions of the wheels (e.g., inside and outside wheels) during a turn. If controller 220 has not steered the wheels as desired, it further decreases the current provided to valve 212, closing valve 212 further and causing the pressure in the steering control system to increase. This, in turn, provides hydraulic fluid under greater pressure through valves 206 and 208 to hydraulic cylinders 202 and 204 to increase the steering force imparted by hydraulic cylinders 202 and 204. This can be continued, as desired, until either the maximum desired steering control pressure has been reached or until the hydraulic cylinders 202 and 204 have been able to rotate the wheels to the desired steering angle.

The present invention thus provides a number of significant advantages. For example, the maximum steering control pressure in the system is not defined by the plumbing of the system but can instead be set by simply changing the software parameters used to define the “load sense” or “load” of the system (and hence the current output to valve 212 given wheel position). Similarly, the entire valving assembly 214 can be eliminated from the system. This saves significant cost and assembly time, particularly in view of the fact that some type of steer angle sensors 302 and 304 may be desired in the system so that controller 220 can operate in a closed loop fashion.

It should also be noted that the inventive aspects of the present invention can be obtained even if sensors 302 and 304 are not position sensors or angle sensors, per se. For example, based on the operator input, controller 220 may desire to control the speed at which the wheels associated with hydraulic cylinders 202 and 204 move through the steering angle. Thus, sensors 302 and 304 can be replaced by speed sensors which give an indication as to the speed at which the wheels associated with hydraulic cylinders 202 and 204 are moving through the desired steering angle. If the wheels are not moving, or moving very slowly through the desired steering angle, controller 220 can reduce the current provided to valve 212, to close valve 212 further and thereby increase the steering pressure in the system such that the steering can be done more quickly, and vice versa.

It will be apparent that the present invention can be used with one or more wheels as well. For instance, in an embodiment in which all wheels on machine 10 are individually steerable, the present invention can be used on all four wheels.

It should also be noted that the novel aspects of the present invention can be applied to other functions, other than the steering function on loader 10. For example, hydraulic actuators 202 and 204 can be associated with the lift or tilt cylinders for manipulating the tool on loader 10. In that case, position sensors 302 and 304 can simply be sensors which indicate the position of the tool or the extent to which the cylinders are extended. Under heavy load conditions, it may be desirable for controller 220 to increase the hydraulic fluid under pressure provided to cylinders 202 and 204 such that the desired hydraulic functions (e.g., lift and tilt) can be accomplished either more quickly or simply utilizing more power to accommodate for bigger loads.

Although the present invention has been described with reference to illustrative embodiments, workers skilled in the art will recognize that changes may be made in form and detail without departing from the spirit and scope of the invention.

What is claimed is:

1. An electro-hydraulic control system on a power machine having at least one steerable wheel connected to a hydraulic steering actuator, the hydraulic control system comprising:
a pump providing hydraulic fluid under pressure;
a flow control valve coupled to the pump and the steering actuator to provide hydraulic fluid under pressure to the steering actuator;
a pressure control valve fluidically coupled between the pump and a hydraulic fluid reservoir;
a sensor disposed relative to the steering actuator to sense a steering characteristic of the steering actuator and provide a sensor output indicative of the steering characteristic; and
a controller coupled to the pressure control valve and the sensor and providing a pressure control signal to the pressure control valve to control hydraulic pressure provided to the flow control valve based on the sensor signal.

2. The electro-hydraulic control system of claim 1 wherein the power machine includes a user input apparatus providing a user input signal indicative of a desired steering operation, and wherein the controller is coupled to the user input apparatus to receive the user input signal.

3. The electro-hydraulic control system of claim 2 wherein the controller is coupled to the flow control valve and configured to control the flow control valve based on the user input signal.

4. The electro-hydraulic control system of claim 3 wherein the sensor comprises:
a steering angle sensor and wherein the steering characteristic comprises a steering angle such that the sensor senses an angle at which the steerable wheel is steered.

5. The electro-hydraulic control system of claim 4 wherein the steering angle sensor comprises a rotational potentiometer.

6. The electro-hydraulic control system of claim 4 wherein the pressure control valve is configured to be open when the steerable wheel is positioned to steer at substantially zero steering angle relative to a longitudinal axis of the power machine such that pressure provided to the flow control valves is substantially zero.

7. The electro-hydraulic control system of claim 3 wherein the steering actuator comprises a hydraulic cylinder and wherein the sensor comprises:
a position sensor coupled to the hydraulic cylinder and wherein the steering characteristic comprises a length to which the hydraulic cylinder is extended such that the position sensor senses the length to which the hydraulic cylinder is extended.

8. An electro-hydraulic control system on a power machine having at least one hydraulic actuator, the hydraulic control system comprising:
a pump providing hydraulic fluid under pressure;
a flow control valve coupled to the pump and the hydraulic actuator to provide hydraulic fluid under pressure to the hydraulic actuator;
a pressure control valve fluidically coupled between the pump and a hydraulic fluid reservoir;
a sensor disposed relative to the hydraulic actuator to sense actuation of the hydraulic actuator and provide a sensor output indicative of the actuation; and
a controller coupled to the pressure control valve and the sensor and providing a pressure control signal to the pressure control valve to control hydraulic pressure provided to the flow control valve based on the sensor signal.

9. The electro-hydraulic control system of claim 8 wherein the power machine includes at least one steerable wheel and wherein the hydraulic actuator comprises a steering actuator coupled to the steerable wheel to steer the wheel, wherein the sensor senses a steering characteristic of the steering actuator.

10. The electro-hydraulic control system of claim 9 wherein the power machine includes a user input apparatus providing a user input signal indicative of a desired steering operation, and wherein the controller is coupled to the user input apparatus to receive the user input signal.

11. The electro-hydraulic control system of claim 10 wherein the controller is coupled to the flow control valve and configured to control the flow control valve based on the user input signal.

12. The electro-hydraulic control system of claim 11 wherein the sensor comprises:
a steering angle sensor and wherein the steering characteristic comprises a steering angle such that the sensor senses an angle at which the steerable wheel is steered.

13. The electro-hydraulic control system of claim 12 wherein the steering angle sensor comprises a rotational potentiometer.

14. The electro-hydraulic control system of claim 12 wherein the pressure control valve is configured to be open when the steerable wheel is not being actuated such that pressure provided to the flow control valves is substantially zero.

15. The electro-hydraulic control system of claim 11 wherein the steering actuator comprises a hydraulic cylinder and wherein the sensor comprises:
a position sensor coupled to the hydraulic cylinder and wherein the steering characteristic comprises a length to which the hydraulic cylinder is extended such that the position sensor senses the length to which the hydraulic cylinder is extended.

16. A power machine, comprising:
a plurality of wheels, at least one of the wheels being steerable;
a hydraulic steering actuator coupled to the at least one steerable wheel to steer the wheel;
a pump providing hydraulic fluid under pressure;
a flow control valve coupled to the pump and the steering actuator to provide hydraulic fluid under pressure to the steering actuator;
a pressure control valve fluidically coupled between the pump and a hydraulic fluid reservoir;
a sensor disposed relative to the steering actuator to sense a steering characteristic of the steering actuator and provide a sensor output indicative of the steering characteristic; and
a controller coupled to the pressure control valve and the sensor and providing a pressure control signal to the pressure control valve to control hydraulic pressure provided to the flow control valve based on the sensor signal.

17. The power machine of claim 16 and further comprising:
a user input apparatus providing a user input signal indicative of a desired steering operation, and wherein the controller is coupled to the user input apparatus to receive the user input signal.

18. The power machine of claim 17 wherein the controller is coupled to the flow control valve and configured to control the flow control valve based on the user input signal.

19. The power machine of claim 18 wherein the sensor comprises:
a steering angle sensor and wherein the steering characteristic comprises a steering angle such that the sensor senses an angle at which the steerable wheel is steered.

20. The power machine system of claim 18 wherein the steering actuator comprises a hydraulic cylinder and wherein the sensor comprises:
a position sensor coupled to the hydraulic cylinder and wherein the steering characteristic comprises a length to which the hydraulic cylinder is extended such that the position sensor senses the length to which the hydraulic cylinder is extended.
